(19) United States
(12) Patent Application Publication
(10) Pub. No.: US 2018/0181658 A1
(43) Pub. Date: Jun. 28, 2018

(54) METHOD AND APPARATUS FOR RECOGNIZING WIFI NAMES OF POINTS OF INTEREST

(71) Applicant: BAIDU ONLINE NETWORK TECHNOLOGY (BEIJING) CO., LTD, Beijing (CN)

(72) Inventors: Yu XU, Beijing (CN); Yunfeng XU, Beijing (CN); Cheng WANG, Beijing (CN)

(73) Assignee: BAIDU ONLINE NETWORK TECHNOLOGY (BEIJING) CO., LTD, Beijing (CN)

(21) Appl. No.: 15/656,639

(22) Filed: Jul. 21, 2017

(30) Foreign Application Priority Data
Dec. 23, 2016 (CN) 201611207302.1

(51) Int. Cl. G06F 17/30

(52) U.S. Cl. CPC G06F 17/30864; H04W 84/12

(57) ABSTRACT

The present disclosure provides a method and apparatus for recognizing a WIFI name of a point of interest, The method comprises respectively performing the following processing for each point of interest to be processed: searching for information in a search engine according to a name of the point of interest; determining a WiFi name of the point of interest by analyzing the search results. The solutions of the present disclosure can be employed to save manpower and material resources and exhibit broad applicability.

The present application claims the priority of Chinese Patent Application No. 201611207302.1, filed on Dec. 23, 2016, with the title of “METHOD AND APPARATUS FOR RECOGNIZING WIFI NAMES OF POINTS OF INTEREST”.

### FIELD OF THE DISCLOSURE

The present disclosure relates to network technologies, and particularly to a method and apparatus for recognizing a WIFI name of a point of interest.

### BACKGROUND OF THE DISCLOSURE

As technologies develop, many businesses no longer put advertisements, promotional information and the like in a purely extensive manner, but hope that the pushed information can attract more users to them. This requires the information to be pushed to user groups as accurately as possible.

For example, when a user is at a certain location, it is feasible to report a WiFi listing of the location, respectively determine shops corresponding to WiFi names in the WiFi listing, and thereby push the promotional information of these shops to users to accurately push information to users nearby the shops and promote user conversion.

Therefore, it is necessary to pre-recognize WiFi names of the shops, namely, determine WiFi names of the shops.

In the prior art, it is usual to recognize WiFi names of shops according to similarity between names of shops and WiFi names, e.g., compare similarity in Chinese and/or Pinyin.

However, this manner is not adapted for many shops because WiFi names of many shops are not similar to names of shops, but have some special WiFi names, e.g., English names.

Regarding the above non-adaptation situation, it is usually necessary to perform on-the-spot investigation to obtain the WiFi names of shops, which requires input of a lot of manpower and material resources.

### SUMMARY OF THE DISCLOSURE

In view of the above, the present disclosure provides a method and apparatus for recognizing a WIFI name of a point of interest, which can save manpower and material resources and exhibit broad applicability.

Specific technical solutions are presented as follows:

A method of recognizing a WiFi name of a point of interest, comprising:

respectively performing the following processing for each point of interest to be processed:

searching for information in a search engine according to a name of the point of interest;

determining a WiFi name of the point of interest by analyzing the search results.

An apparatus for recognizing a WiFi name of a point of interest, comprising: a searching unit and an analyzing unit;

the searching unit is configured to, for each point of interest to be processed, perform searching for information in a search engine according to a name of the point of interest to obtain search results;

the analyzing unit is configured to determine a WiFi name of the point of interest by analyzing the search results obtained by the searching unit.

It can be seen from the above introduction that the solutions of the present disclosure may be employed to perform search for information in the search engine according to the name of the point of interest, and determine the WiFi name of the point of interest by analyzing the search results, thereby overcoming problems existing in the prior art, saving manpower and material resources as well as exhibiting broad applicability owing to adaptation to any point of interest.

### BRIEF DESCRIPTION OF DRAWINGS

FIG. 1 is a flow chart of a method embodiment of recognizing a WiFi name of a point of interest according to the present disclosure;

FIG. 2 is a flow chart of a first preferred embodiment of a method of recognizing a WiFi name of a point of interest according to the present disclosure;

FIG. 3 is a flow chart of a second preferred embodiment of a method of recognizing a WiFi name of a point of interest according to the present disclosure;

FIG. 4 is a block diagram of an apparatus embodiment of recognizing a WiFi name of a point of interest according to the present disclosure.

### DETAILED DESCRIPTION OF PREFERRED EMBODIMENTS

In view of problems existing in the prior art, the present disclosure provides a solution of recognizing a WiFi name of a point of interest, to mine the WiFi name of the point of interest according to knowledge information provided by a search engine, thereby overcoming problems existing in the prior art.

To make technical solutions of the present disclosure clearer and more apparent, the technical solutions of the present disclosure will be further described in detail by referring to figures and presenting embodiments.

### Embodiment 1

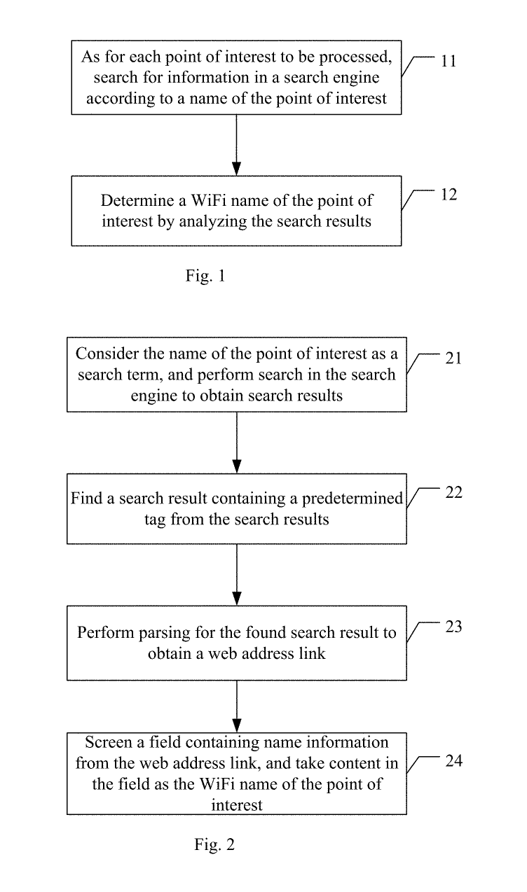

FIG. 1 is a flow chart of a method embodiment of recognizing a WiFi name of a point of interest according to the present disclosure. As shown in FIG. 1, the method comprises the following specific steps:

At step 11, for each point of interest to be processed, searching for information is performed in a search engine according to a name of a point of interest;

At step 12, a WiFi name of the point of interest is determined by analyzing search results.

It is feasible to, for each point of interest to be processed, perform searching for information in a search engine according to the name of the point of interest, and thereby determine the WiFi name of the point of interest by analyzing the search results.

For example, there may be the following two implementation manners:

1) Manner 1

FIG. 2 is a flow chart of a first preferred embodiment of a method of recognizing a WiFi name of a point of interest according to the present disclosure. As shown in FIG. 2, the method comprises the following specific steps:

At step 21, the name of the point of interest is considered as a search term, and search is performed in the search engine to obtain search results.

The name of the point of interest is directly considered as a search term and entered into the search engine to obtain search results.

At step 22, a search result containing a predetermined tag is found from the search results.

A specific type of the predetermined tag may depend on actual needs.

For example, a search result containing “official website” tag may be found from the search results.

At step 23, paring is performed for the found search result to obtain a web address link.

For example, the web address link of the official website of the point of interest may be obtained by paring the found search results.

How to perform parsing is of the prior art.

At step 24, a field containing name information is screened from the web address link, and content in the field is taken as the WiFi name of the point of interest.

Regarding the web address link obtained from the parsing, it is further feasible to screen therefrom a specific field including the name information, and thereby take the content in the field as the WiFi name of the interest of point.

For example, it is possible to take positions of symbols . in the web address link as segmenting positions to segment the web address link to obtain segmented fields, and then consider a first field after the field where “www” lies as a field containing the name information.

As for each point of interest to be processed, processing is performed respectively in the manner shown in FIG. 2 to respectively obtain the WiFi name of each point of interest.

The manner shown in FIG. 2 may be exemplified as follows:

Assume that the name of the point of interest to be processed is “**hotel”;

“**hotel” is taken as the search term and entered into the search engine for searching to obtain corresponding search results;

A search result, usually one search result containing an “official website” is found from the search results;

Parsing is performed for the found search result to obtain a web address link such as http://www.7daysinn.cn/;

The web address link is segmented according to symbols ., i.e., positions of symbols . in the web address link are taken as segmenting positions to segment the web address link to obtain segmented fields, including http://www, 7daysinn and en/;

The content in the first field after the field where “www” lies as the WiFi name of “**hotel”, namely, 7daysinn is taken as the WiFi name of the point of interest “**hotel”.

2) Manner 2

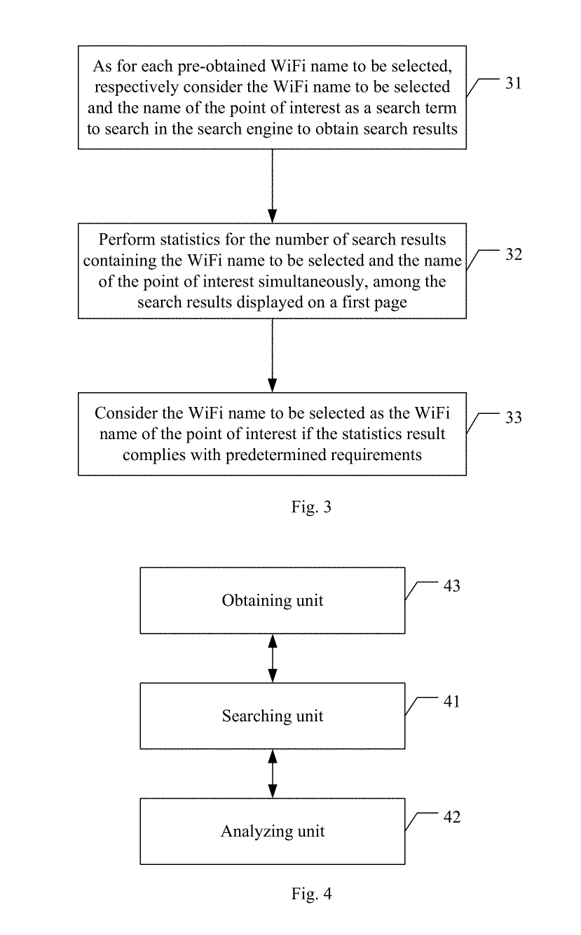

FIG. 3 is a flow chart of a second preferred embodiment of a method of recognizing a WiFi name of a point of interest according to the present disclosure. As shown in FIG. 3, the method comprises the following steps:

At step 31, as for each pre-obtained WiFi name to be selected, the WiFi name to be selected and the name of the point of interest are respectively considered as search terms to search in the search engine to obtain search results.

It is feasible to obtain a WiFi listing at the position as reported by the user and consider the WiFi names appearing in the WiFi listing as the WiFi names to be selected.

Regarding each WiFi name to be selected, it is feasible to consider it together with the name of the point of interest as the search term, enter them into the search engine for search to obtain search results.

At step 32, statistics is performed for the number of search results containing the WiFi name to be selected and the name of the point of interest simultaneously, among the search results displayed on the first page.

Since the search results displayed on the first page are usually search results more relevant to the search term, statistics may be performed only for the search results displayed on the first page to collect the number of search results containing the WiFi name to be selected and the name of the point of interest simultaneously.

At step 33, if the statistics result complies with predetermined requirements, the WiFi name to be selected is considered as the WiFi name of the point of interest.

How to determine whether the statistics result complies with predetermined requirements depends on actual needs.

For example, if the statistics result is larger than a predetermined threshold, the statistics result may be considered as complying with the predetermined requirements, and the WiFi name to be selected is considered as the WiFi name of the point of interest.

A specific value of the threshold may depend on actual needs.

For example, the search results displayed on the first page include totally 10 search results, wherein five search results simultaneously contain the WiFi name to be selected and the name of the point of interest, greater than the threshold 4, the WiFi name to be selected may be considered as the WiFi name of the point of interest.

As for each point of interest to be processed, processing is performed respectively in the manner shown in FIG. 3 to respectively obtain the WiFi name of each point of interest.

It needs to be appreciated that in practical application, since the user constantly reports information of the WiFi listing, the WiFi listings reported by the user may be aggregated periodically, namely, WiFi names in the WiFi listing obtained in the latest one period are considered as the WiFi names to be selected.

Or, interference that might exist may be removed first, namely, the WiFi names that seldom appear, for example, appear once are removed, and WiFi names that appear in the WiFi listing more times are considered as the WiFi names to be selected.

In each cycle, after WiFi names to be selected are determined, the WiFi names of the points of interest to be processed may be determined in the manner as shown in FIG. 3; in addition, all points of interest may be considered as the points of interest to be processed, and their WiFi names be determined respectively, or, repeated determination may not be performed for the points of interest whose WiFi names have already been determined in the previous cycle. The specific implementation manner is not limited and may depend on actual needs.

The manner shown in FIG. 3 may be exemplified as follows:

Assume that the name of the point of interest to be processed is “**hotel” and assume that the number of WiFi names to be selected is three: WiFi name 1, WiFi name 2 and WiFi name 3 respectively;

The “**hotel” and WiFi name 1 are considered as the search term and entered into the search engine for search to obtain corresponding search results;

Statistics is performed for the number of search results simultaneously containing “**hotel” and WiFi name 1 among the search results displayed on the first page. If the statistics result is smaller than a threshold, it is determined that WiFi name 1 is not the WiFi name of “**hotel”;

Then, the “**hotel” and WiFi name 2 are considered as the search term and entered into the search engine for search to obtain corresponding search results;

Statistics is performed for the number of search results simultaneously containing “**hotel” and WiFi name 2 among the search results displayed on the first page. If the statistics result is smaller than a threshold, it is determined that WiFi name 2 is not the WiFi name of “**hotel”;

Then, the “**hotel” and WiFi name 3 are considered as the search term and entered into the search engine for search to obtain corresponding search results;

Statistics is performed for the number of search results simultaneously containing “**hotel” and WiFi name 3 among the search results displayed on the first page. If the statistics result is larger than a threshold, it is determined that WiFi name 3 is the WiFi name of “**hotel”.

The method embodiment is introduced above. The solutions of the present disclosure will be further described below through an apparatus embodiment.

### Embodiment 2

FIG. 4 is a block diagram of an apparatus embodiment of recognizing a WiFi name of a point of interest according to the present disclosure. As shown in FIG. 4, the apparatus comprises: a searching unit 41 and an analyzing unit 42.

The searching unit 41 is configured to, for each point of interest to be processed, perform searching for information in a search engine according to a name of a point of interest to obtain search results.

The analyzing unit 42 is configured to determine a WiFi name of the point of interest by analyzing the search results obtained by the searching unit 41.

In practical application, there may be the following two implementation manners:

1) Manner 1

In this manner, the searching unit 41 may consider the name of the point of interest as a search term, and perform search in the search engine to obtain search results.

The analyzing unit 42 may find a search result containing a predetermined tag from the search results, perform parsing for the found search result to obtain a web address link, and screen a field containing name information from the web address link, and take content in the field as the WiFi name of the point of interest.

For example, the analyzing unit 42 may find a search result containing “official website” tag from the search results, perform parsing for the found search result to obtain a web address link of the official website of the point of interest, further screen a specific field containing name information from the web address link obtained from the parsing, and take content in the field as the WiFi name of the point of interest.

Specifically, the analyzing unit 42 may take positions of symbols . in the web address link as segmenting positions to segment the web address link to obtain segmented fields, and then consider a first field after the field where “www” lies as a field containing the name information.

2) Manner 2

In this manner, the searching unit 41 may, as for each pre-obtained WiFi name to be selected, consider the WiFi name to be selected together with the name of the point of interest as a search term to search in the search engine to obtain search results.

The analyzing unit 42 may perform statistics for the number of search results containing the WiFi name to be selected and the name of the point of interest simultaneously, among the search results displayed on the first page, and consider the WiFi name to be selected as the WiFi name of the point of interest if the statistics result complies with predetermined requirements.

As shown in FIG. 4, the apparatus embodiment may further comprise an obtaining unit 43.

The obtaining unit 43 is configured to obtain a WiFi listing at the position as reported by the user and consider the WiFi names appearing in the WiFi listing as the WiFi names to be selected.

Regarding each WiFi name to be selected, the searching unit 41 may consider it together with the name of the point of interest as the search term, enter them into the search engine for search to obtain search results.

Since the search results displayed on the first page are usually search results more relevant to the search term, the analyzing unit 42 may perform statistics only for the search results displayed on the first page to collect the number of search results containing the WiFi name to be selected and the name of the point of interest simultaneously, and consider the WiFi name to be selected as the WiFi name of the point of interest if the statistics result complies with predetermined requirements.

For example, the analyzing unit 42 may consider the WiFi name to be selected as the WiFi name of the point of interest upon determining that the statistics result is larger than the predetermined threshold.

Reference may be made to corresponding depictions in the above method embodiment for a specific workflow of the apparatus embodiment shown in FIG. 4, and the workflow will not be detailed any more herein

In one word, the solutions of the present disclosure may be employed to perform search for designated information in the search engine according to the name of the point of interest, and determine the WiFi name of the point of interest by analyzing the search results, thereby overcoming problems existing in the prior art, saving manpower and material resources as well as exhibiting broad applicability.

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

It is appreciated that what are stated above are only preferred embodiments of the present disclosure, not intended to limit the disclosure. Any modifications, equivalent replacements, improvements and the like made within the spirit and principles of the present disclosure, should all be included in the scope as protected by the present disclosure.

What is claimed is:

1. A method of recognizing a WiFi name of a point of interest, wherein the method comprises respectively performing the following processing for each point of interest to be processed:
searching for information in a search engine according to a name of the point of interest;
determining a WiFi name of the point of interest by analyzing the search results.

2. The method according to claim 1, wherein,
the searching for information in a search engine according to a name of the point of interest comprises:
considering the name of the point of interest as a search term, and performing search in the search engine to obtain search results;
the determining a WiFi name of the point of interest by analyzing the search results comprises:
finding a search result containing a predetermined tag from the search results;
performing parsing for the found search result to obtain a web address link, and
screening a field containing name information from the web address link, and taking content in the field as the WiFi name of the point of interest.

3. The method according to claim 2, wherein,
the screening a field containing name information from the web address link comprises:
taking positions of symbols . in the web address link as segmenting positions to segment the web address link to obtain segmented fields,
considering a first field after the field where “www” lies as the field containing the name information.

4. The method according to claim 1, wherein,
the searching for information in a search engine according to a name of the point of interest comprises:
as for each pre-obtained WiFi name to be selected, respectively considering the WiFi name to be selected and the name of the point of interest as a search term to search in the search engine to obtain search results;
the determining a WiFi name of the point of interest by analyzing the search results comprises:
performing statistics for the number of search results containing the WiFi name to be selected and the name of the point of interest simultaneously, among the search results displayed on a first page;
considering the WiFi name to be selected as the WiFi name of the point of interest if the statistics result complies with predetermined requirements.

5. The method according to claim 4, wherein,
the method further comprises:
obtaining a WiFi listing at a position as reported by the user;
considering the WiFi names appearing in the WiFi listing as the WiFi names to be selected.

6. The method according to claim 4, wherein,
the statistics result complying with predetermined requirements comprises:
the statistic result is larger than a predetermined threshold.

7. A device for recognizing a WiFi name of a point of interest, comprising:
at least one processor; and
a memory storing instructions, which when executed by the at least one processor, cause the at least one processor to perform operation, the operation comprising:
respectively performing the following processing for each point of interest to be processed:
searching for information in a search engine according to a name of the point of interest;
determining a WiFi name of the point of interest by analyzing the search results.

8. The device according to claim 7, wherein,
the operation of searching for information in a search engine according to a name of the point of interest comprises:
considering the name of the point of interest as a search term, and performing search in the search engine to obtain search results;
the operation of determining a WiFi name of the point of interest by analyzing the search results comprises:
finding a search result containing a predetermined tag from the search results;
performing parsing for the found search result to obtain a web address link, and
screening a field containing name information from the web address link, and taking content in the field as the WiFi name of the point of interest.

9. The device according to claim 8, wherein,
the operation of screening a field containing name information from the web address link comprises:
taking positions of symbols . in the web address link as segmenting positions to segment the web address link to obtain segmented fields,
considering a first field after the field where “www” lies as the field containing the name information.

10. The device according to claim 7, wherein,
the operation of searching for information in a search engine according to a name of the point of interest comprises:
as for each pre-obtained WiFi name to be selected, respectively considering the WiFi name to be selected and the name of the point of interest as a search term to search in the search engine to obtain search results;
the operation of determining a WiFi name of the point of interest by analyzing the search results comprises:
performing statistics for the number of search results containing the WiFi name to be selected and the name of the point of interest simultaneously, among the search results displayed on a first page;
considering the WiFi name to be selected as the WiFi name of the point of interest if the statistics result complies with predetermined requirements.

11. The device according to claim 10, wherein,
the operation further comprises:
obtaining a WiFi listing at a position as reported by the user;
considering the WiFi names appearing in the WiFi listing as the WiFi names to be selected.

12. The device according to claim 10, wherein,
the statistics result complying with predetermined requirements comprises:
the statistic result is larger than a predetermined threshold.

13. A computer storage medium, wherein the computer storage medium is coded with a computer program, and when the program is executed by one or more computers, the one or more computers perform the following operation:
respectively performing the following processing for each point of interest to be processed:
searching for information in a search engine according to a name of the point of interest;
determining a WiFi name of the point of interest by analyzing the search results.

14. The computer storage medium according to claim 13, wherein,
the operation of searching for information in a search engine according to a name of the point of interest comprises:
considering the name of the point of interest as a search term, and performing search in the search engine to obtain search results;
the operation of determining a WiFi name of the point of interest by analyzing the search results comprises:
finding a search result containing a predetermined tag from the search results;
performing parsing for the found search result to obtain a web address link, and
screening a field containing name information from the web address link, and taking content in the field as the WiFi name of the point of interest.

15. The computer storage medium according to claim 14, wherein,
the operation of screening a field containing name information from the web address link comprises:
taking positions of symbols . in the web address link as segmenting positions to segment the web address link to obtain segmented fields,
considering a first field after the field where “www” lies as the field containing the name information.

16. The computer storage medium according to claim 13, wherein,
the operation of searching for information in a search engine according to a name of the point of interest comprises:
as for each pre-obtained WiFi name to be selected, respectively considering the WiFi name to be selected and the name of the point of interest as a search term to search in the search engine to obtain search results;
the operation of determining a WiFi name of the point of interest by analyzing the search results comprises:
performing statistics for the number of search results containing the WiFi name to be selected and the name of the point of interest simultaneously, among the search results displayed on a first page;
considering the WiFi name to be selected as the WiFi name of the point of interest if the statistics result complies with predetermined requirements.

17. The computer storage medium according to claim 16, wherein,
the operation further comprises:
obtaining a WiFi listing at a position as reported by the user;
considering the WiFi names appearing in the WiFi listing as the WiFi names to be selected.

18. The computer storage medium according to claim 16, wherein,
the statistics result complying with predetermined requirements comprises:
the statistic result is larger than a predetermined threshold.
